(19) United States
(12) Patent Application Publication
(10) Pub. No.: US 2025/0153776 A1
(43) Pub. Date: May 15, 2025

(54) DEVICE FOR REINFORCING A SIDE PART OF AN ELECTRIC VEHICLE BODY

(71) Applicants: HYUNDAI MOTOR COMPANY, Seoul (KR); KIA CORPORATION, Seoul (KR)

(72) Inventors: Do Yeop Kang, Gwangyang-si (KR); Huen Sick Min, Hwaseong-si (KR)

(73) Assignees: HYUNDAI MOTOR COMPANY, Seoul (KR); KIA CORPORATION, Seoul (KR)

(21) Appl. No.: 18/633,702

(22) Filed: Apr. 12, 2024

(30) Foreign Application Priority Data
Nov. 13, 2023 (KR) 10-2023-0156000

(51) Int. Cl. B62D 25/02; B60L 50/60; B62D 21/15

(52) U.S. Cl. CPC B62D 25/025; B60L 50/66; B62D 21/157

(57) ABSTRACT

A device for reinforcing a side part of an electric vehicle body, in which load-supporting structures supporting a bottom part of a side sill inner reinforcement may be installed on a side sill inner panel to ensure that the side sill inner reinforcement remains secured in place. As a result of the configuration, weight reduction compared to conventional technology is realized and a collision energy absorption performance following a small overlap collision and a side collision is improved.

### CROSS-REFERENCE TO RELATED APPLICATION

The present application claims the benefit of and priority to Korean Patent Application No. 10-2023-0156000, filed Nov. 13, 2023, the entire contents of which are incorporated herein for all purposes by this reference.

### BACKGROUND

### Technical Field

The present disclosure relates to a device for reinforcing a side part of an electric vehicle body. More particularly, the present disclosure relates to a device for reinforcing a side part of an electric vehicle body by improving collision energy absorption performance.

### Description of the Related Art

As the launch and distribution of electric vehicles becomes more common, continuous research and development is being dedicated to enhancing the design of electric vehicle bodies to satisfy a variety of crash performance requirements.

In particular, among vehicle body structures for electric vehicles, a side part of an electric vehicle is used in a structure to protect a cabin room and battery pack from a small overlap collision and a side collision.

The accompanying FIG. 1 is a perspective view of an example of a side part of a conventional electric vehicle body. FIG. 2 is a schematic sectional view of the example of a side part of a conventional electric vehicle body.

As shown in FIGS. 1 and 2, side sill inner panels 20 are respectively joined through welding or the like to opposite sides of a seat-cross member 10 that supports the interior floor panel of the vehicle. On the outer side of each of the side sill inner panels 20, a side sill inner reinforcement 30-1, which is a type of collision energy absorbing part, is arranged.

In addition, a side sill outer panel 40 that covers the respective side sill inner reinforcement 30-1 is joined to the outer surface of a respective side sill inner panel 20 through welding or the like.

Accordingly, as shown in FIG. 2, the side sill inner reinforcement 30-1 may be positioned in a sealed space between the side sill inner panel 20 and the side sill outer panel 40 to absorb shock.

At this time, as shown in FIG. 2, the side sill inner reinforcement 30-1 may be inserted into and fastened to a fastening pipe 22 mounted on the bottom part of the side sill inner panel 20 to be maintained in a secured state.

However, the side part of the electric vehicle body according to the conventional example has the following problems.

Among the side part configuration of the electric vehicle body according to the conventional example, the side sill inner reinforcement 30-1 has the disadvantages of having a large sectional area, large volume, and being heavy. Accordingly, the disadvantages increase the weight of the electric vehicle.

Among the side part configuration of the electric vehicle body according to the conventional example, the side sill inner reinforcement 30-1 is characterized by a large sectional area and volume, making it heavy. Consequently, these drawbacks contribute to an increase in the overall weight of the electric vehicle.

Accompanying FIG. 3 is a schematic sectional view of another example of a side part of the conventional electric vehicle body.

The side part of the electric vehicle body according to another conventional example is characterized in that it is structured to reduce the weight of the electric vehicle.

To this end, among the side part configuration of the electric vehicle body according to another conventional example, a side sill inner reinforcement 30-2 is applied in a structure that has a reduced sectional area, volume, and weight, compared to the side sill inner reinforcement (30-1).

As shown in FIG. 3, side sill inner panels 20 are respectively joined to the opposite sides of the seat-cross member 10 that supports the interior floor panel of the vehicle through welding or the like. On the outer side of each side sill inner panel 20, the side sill inner reinforcement 30-2, which is a type of collision energy absorbing component, is arranged.

In addition, each side sill inner reinforcement 30-2 is covered by a side sill outer panel 40 that is joined to the outer surface of a respective side sill inner panel 20 through welding or the like.

Accordingly, as shown in FIG. 3, the side sill inner reinforcement 30-2 may be positioned in a sealed space between the side sill inner panel 20 and the side sill outer panel 40 to absorb shock.

For reference, a battery pack may be located at the bottom part of the seat-cross member 10.

As shown in FIG. 3, the side sill inner reinforcement 30-2 is in close contact with the outer surface of the side sill inner panel 20 and is coupled by a fastening bolt 24.

To elaborate, after an inner end part of the side sill inner reinforcement 30-2 is closely aligned with the outer surface of the side sill inner panel 20, the fastening bolt 24 is inserted and fastened into the side sill inner panel 20 from an inner end of the side sill inner reinforcement 30-2. This ensures that the side sill inner reinforcement 30-2 may be maintained in a secured state.

However, although the side part of the body for an electric vehicle according to another conventional example may realize weight reduction by reducing the sectional area, volume, and weight of the side sill inner reinforcement 30-2, there are following problems.

First, the inner end of the side sill inner reinforcement 30-2 is secured to the side sill inner panel 20 solely by the fastening bolt 24, without any load-supporting structure supporting the bottom part of the side sill inner reinforcement 30-2. Therefore, a problem arises in that the side sill inner reinforcement 30-2 may sag downward due to its own weight.

Second, when the side sill inner reinforcement 30-2 sags downward due to its own weight, it may generate noise due to driving vibrations. Furthermore, when a small overlap collision and a side collision occur, a problem arises where the side sill inner reinforcement 30-2 fails to accurately absorb collision energy.

The information in the Description of the Related Art section is intended merely to aid in the understanding of the background of the present disclosure. Therefore, the information in the Description of the Related Art section is not intended to mean that the present disclosure falls within the purview of the related art that is already known to those having ordinary skill in the art.

### SUMMARY

The present disclosure has been made keeping in mind the above problems occurring in the related art. The present disclosure is intended to provide a device for reinforcing a side part of an electric vehicle body in which load-supporting structures supporting a bottom part of a side sill inner reinforcement are installed on a side sill inner panel to ensure that the side sill inner reinforcement remains secured in place. As a result, the collision energy absorption performance following a small overlap collision and a side collision is improved, and weight reduction compared to conventional technology is realized.

In order to achieve the above objectives, according to the present disclosure, there may be provided a device for reinforcing a side part of an electric vehicle body. The device includes a side sill inner panel configured to be coupled to each opposite side of a seat-cross member. The device may also include a side sill inner reinforcement configured to be attached to an outer surface of the side sill inner panel. The device may also include a battery mounting pipe having an upper part configured to be coupled to a bottom part of the side sill inner reinforcement and a lower part configured to be coupled to a lower plate part of the side sill inner panel.

In the device for reinforcing a side part of an electric vehicle body, the device may further include a side sill inner patch having an upper part configured to be coupled to a bottom part of the side sill inner reinforcement and a lower part configured to be coupled to a lower circumference part of the battery mounting pipe.

The side sill inner patch may include a first side sill inner patch provided in a structure configured to support the bottom part of the side sill inner reinforcement, along with the battery mounting pipe. The side sill inner patch may further include a second side sill inner patch provided in a structure configured to support the bottom part of the side sill inner reinforcement, along with the battery mounting pipe, and to cover a part of an outer surface and upper surface, of the side sill inner reinforcement.

The first side sill inner patch may include an upper support plate configured to be fastened to the bottom part of the side sill inner reinforcement with bolts and simultaneously welded to an upper-end part of the battery mounting pipe. The first side sill inner patch may include a lower support plate configured to be welded to the lower circumference part of the battery mounting pipe. Additionally, the first side sill inner patch may include a vertical support plate configured to be integrally connected between an inner end of the upper support plate and an inner end of the lower support plate and arranged parallel to the outer surface of the side sill inner panel in a vertical direction.

The second side sill inner patch may include an upper support plate configured to be fastened to the bottom part of the side sill inner reinforcement with bolts and simultaneously welded to an upper-end part of the battery mounting pipe. The second side sill inner patch may include a lower support plate configured to be welded to the lower circumference part of the battery mounting pipe. The second side sill inner patch may include a vertical support plate configured to be integrally connected between an inner end of the upper support plate and an inner end of the lower support plate and arranged parallel to the outer surface of the side sill inner panel in the vertical direction. The second side sill inner patch may further include a protector that is bent in two steps from an outer end part of the upper support plate and extends upward to cover the part of an outer surface and upper surface of the side sill inner reinforcement. Additionally, the second side sill inner patch may include an upper coupling plate extending from an upper-end part of the protector and joined to an upper-end part of the side sill inner panel through welding or the like.

The outer surface of the side sill inner reinforcement and the inner surface of the side sill inner panel may be bonded using an adhesive or adhesive tape.

The battery mounting pipe may be provided in a structure having a female thread part and an inner diameter part. The female threaded part may be provided on the inner diameter part. Additionally, when the lower-end part of the battery mounting pipe is coupled to the lower plate of the side sill inner panel, the female thread part may be exposed beneath the lower plate of the side sill inner panel.

In addition, a flange part of a battery pack may be in close contact with a bottom surface of the lower plate part of the side sill inner panel. A battery fastening bolt may be inserted into and fastened, from the flange part, to the female thread part of the battery mounting pipe.

As described above, the present disclosure solves the above problems, thereby providing the following effects.

First, a plurality of load-supporting structures (side sill inner patches, battery mounting pipes, and the like) that support the bottom part of the side sill inner reinforcement is installed on the side sill inner panel to ensure that the side sill inner reinforcement remains secured in its original position. As a result, the pushing and movement of the side sill inner reinforcement in the event of a small overlap collision or a side collision can be minimized. Accordingly, the performance of absorbing collision energy due to collision can be improved.

Second, the side sill inner reinforcement of the present disclosure can be applied in a structure with reduced sectional area, volume, and weight compared to the conventional side sill inner reinforcement, thereby realizing weight reduction.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a perspective view of an example of a side part of a vehicle body for a conventional electric vehicle;

FIG. 2 is a schematic sectional view of an example of a side part of a vehicle body for a conventional electric vehicle;

FIG. 3 is a schematic sectional view of another example of a side part of a vehicle body for a conventional electric vehicle;

FIG. 4 is a perspective view of a device for reinforcing a side part of an electric vehicle body according to an embodiment of the present disclosure;

FIG. 5 is a side view of a main part of a device for reinforcing a side part of an electric vehicle body according to an embodiment of the present disclosure;

FIG. 6 is a sectional view of a part where a first side sill inner patch of a device for reinforcing a side part of an electric vehicle body according to an embodiment of the present disclosure is installed;

FIG. 7 is a sectional view of a part where a second side sill inner patch of a device for reinforcing a side part of an electric vehicle body according to an embodiment of the present disclosure is installed;

FIG. 8 is a sectional view of an example in which a battery pack is assembled in a device for reinforcing a side part of an electric vehicle body according to an embodiment of the present disclosure; and

FIG. 9 is a sectional view of a shock absorption operation of a device for reinforcing a side part of an electric vehicle body according to an embodiment of the present disclosure.

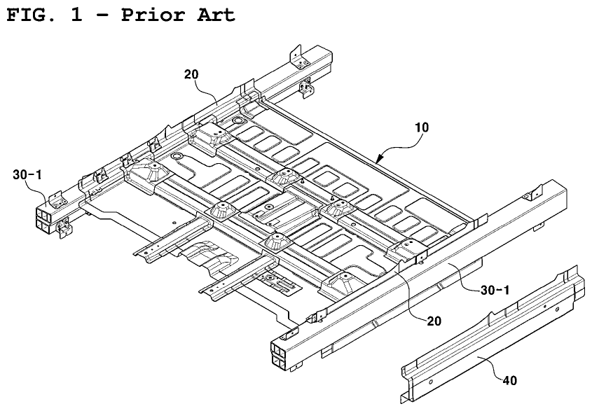

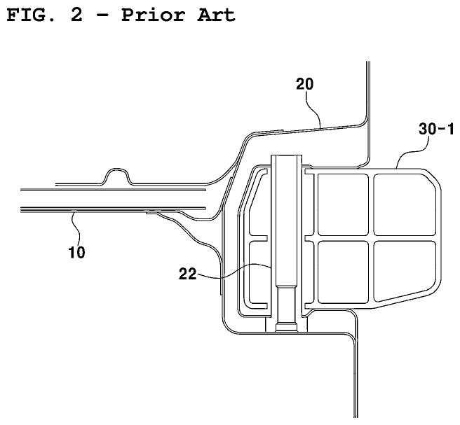

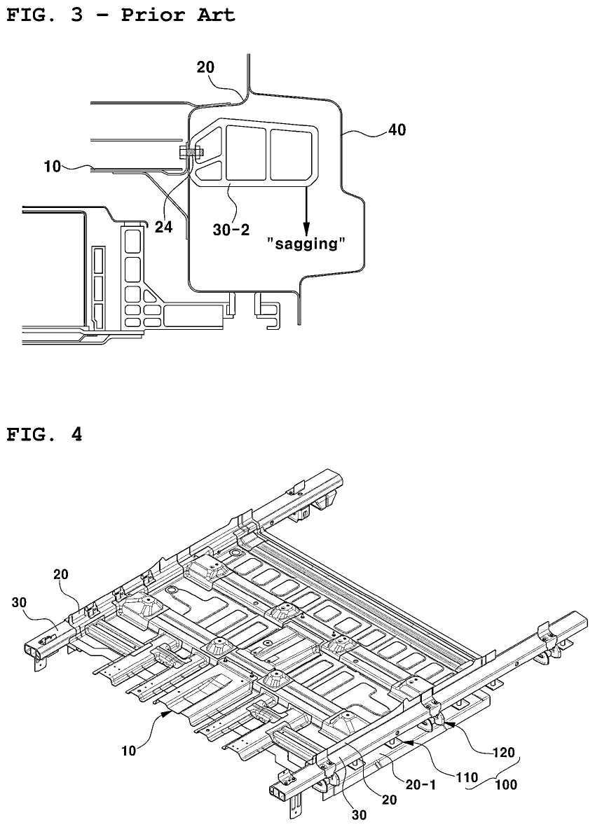

### DETAILED DESCRIPTION

Specific structural and functional descriptions described in the embodiments of the present disclosure are merely exemplified for the purpose of explaining the embodiments according to a concept of the present disclosure. The embodiments according to the concept of the present disclosure may be implemented in various forms. In addition, the inventive concept should not be construed to be limited by the embodiments described in the present disclosure and should be understood to include all modifications, equivalents, or substitutes included in the spirit and technical scope thereof.

In the present disclosure, terms such as first and/or second may be used to describe various components, but the components are not limited by the terms. The above terms are used only for the purpose of distinguishing one component from other components. For example, within a range not departing from the scope of rights according to the concept of the present disclosure, a first component may be referred to as a second component, and similarly, the second component may also be referred to as the first component.

In the present disclosure, it should be understood that when a component is referred to as being “coupled” or “connected” to another component, it may be directly coupled or connected to another component, but other components may even exist in the middle. On the other hand, when a component is referred to as being “directly coupled” or “directly connected” to another component, it should be understood that no other component exists in the middle. Other expressions used to describe the relationship between each component, such as “between” and “directly between” or “adjacent to” and “directly adjacent to,” should be interpreted similarly. When a component, device, element, or the like of the present disclosure is described as having a purpose or performing an operation, function, or the like, the component, device, or element should be considered herein as being “configured to” meet that purpose or to perform that operation or function.

Like reference numbers indicate like elements throughout the present disclosure. Terms used in the present disclosure are for describing the embodiments and are not intended to limit the present disclosure. In the present disclosure, a singular form also includes a plural form unless specifically stated in a phrase. As used herein, “comprises” and/or “comprising” implies that a stated component, step, operation, and/or element does not rule out the presence or addition of one or more other components, steps, operations, and/or elements.

Hereinbelow, embodiments of the present disclosure are described in detail with reference to the accompanying drawings.

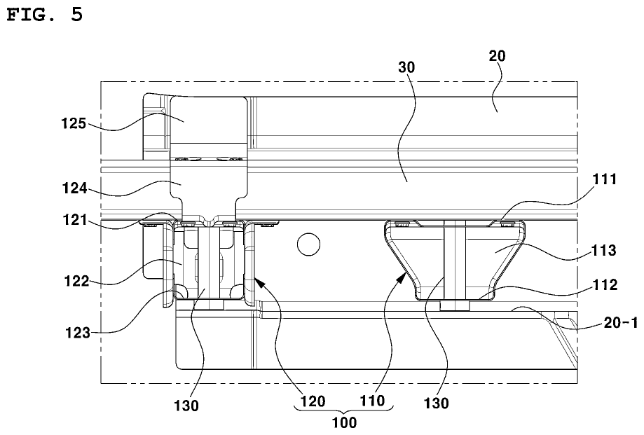

Accompanying FIG. 4 is a perspective view of a device for reinforcing a side part of an electric vehicle body according to the present disclosure, and FIG. 5 is a side view of a main part of the device for reinforcing a side part of an electric vehicle body according to the present disclosure.

As shown in FIG. 4, a side sill inner panel 20 is coupled, through welding or like, to each of opposite sides of the seat-cross member 10, which supports an interior floor panel of the vehicle. A side sill inner reinforcement 30, which is a type of a collision energy absorbing part, is attached to an outer surface of the side sill inner panel 20.

The side sill inner reinforcement 30 is configured to absorb a collision load (collision energy) introduced during a side collision and a small overlap collision. As a result, the side sill inner reinforcement 30 protects the vehicle interior space and simultaneously serves to prevent deformation of the battery pack disposed at the bottom part of the side sill inner panel 20.

In particular, between a lower plate part 20-1 of the side sill inner panel 20 and a bottom part of the side sill inner reinforcement 30, as load-supporting structures supporting the side sill inner reinforcement 30, a plurality of side sill inner patches 100 and a plurality of battery mounting pipes 130 are mounted.

When the material of the side sill inner reinforcement 30 is the same steel material as the battery mounting pipe 130, an upper-end part of the battery mounting pipe 130 may be coupled to the bottom part of the side sill inner reinforcement 30. Additionally, the lower-end part of the battery mounting pipe 130 may be coupled to the lower plate part of the side sill inner panel 20.

Accordingly, the battery mounting pipe 130 serves to act like a pillar of a building, thereby preventing the side sill inner reinforcement 30 from sagging due to its own weight.

When the material of the side sill inner reinforcement 30 is aluminum, which differs from the steel material used for the battery mounting pipe 130, the battery mounting pipe 130 is coupled to the side sill inner patch 100 disposed between the side sill inner panel 20 and the side sill inner reinforcement 30.

In other words, when the material of the side sill inner reinforcement 30 is aluminum, which differs from the steel material used for the battery mounting pipe 130, the upper-end part of the battery mounting pipe 130 may be coupled to the upper support plate of the side sill inner patch 100 through welding or the like. The lower-end part of the battery mounting pipe 130 may be coupled to the lower support plate of the side sill inner patch 100 through welding or the like.

The battery mounting pipe 130 may be provided in a structure having a female thread part 132 provided on its inner diameter part.

Accordingly, when the lower-end part of the battery mounting pipe 130 is coupled to the side sill inner reinforcement 30 or the side sill inner patch 100, the female thread part 132 may be opened and exposed toward the bottom part of the lower plate part 20-1 of the side sill inner panel 20.

The plurality of battery mounting pipes 130 mounted between the lower plate part 20-1 of the side sill inner panel 20 and the bottom part of the side sill inner reinforcement 30 supports the weight (load) of the side sill inner reinforcement 30. Additionally, the plurality of battery mounting pipes 130 performs functions such as preventing the side sill inner reinforcement 30 from sliding, suppressing its initial movement, and the like in the event of a side collision or a small overlap collision.

An upper-end part of the side sill inner patch 100 is coupled to the bottom part of the side sill inner reinforcement 30, and the lower-end part of the side sill inner patch 100 is coupled to the lower circumference part of the battery mounting pipes 130.

The side sill inner patch 100 is a type of support bracket having different shapes and structures. The side sill inner patch 100 may be composed of a first side sill inner patch 110 and a second side sill inner patch 120.

The first side sill inner patch 110 may be provided with a shape and structure supporting the bottom part of the side sill inner reinforcement 30 together with the respective battery mounting pipe 130. The second side sill inner patch 120 may be provided in a structure that not only supports the bottom part of the side sill inner reinforcement 30 together with the respective battery mounting pipe 130, but also covers a part of the outer and upper surfaces of the side sill inner reinforcement 30.

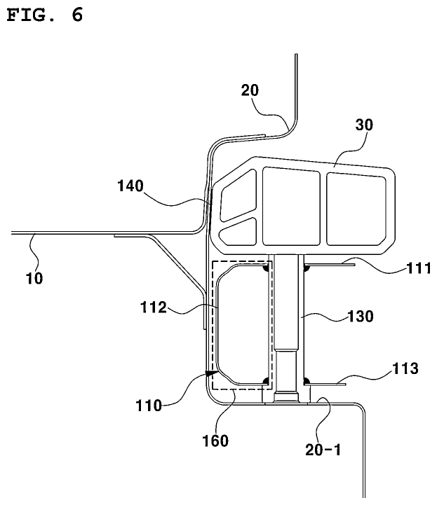

As shown in FIGS. 5 and 6, the first side sill inner patch 110 may include an upper support plate 111 that is fastened to the bottom part of the side sill inner reinforcement 30 with bolts and simultaneously welded to the upper-end part of the battery mounting pipe 130. The upper support plate 111 is arranged horizontally at the lower position of the side sill inner reinforcement 30. The first side sill inner patch 110 may also include a lower support plate 113 that is welded to the lower circumference part of the battery mounting pipe 130 and horizontally arranged above the lower plate 20-1 of the side sill inner panel 20. Additionally, the first side sill inner patch 110 may include a vertical support plate 112 that is integrally connected between the inner end of the upper support plate 111 and the inner end of the lower support plate 113 and arranged parallel to the outer surface of the side sill inner panel 20 in the vertical direction.

As depicted by a dotted box in FIG. 6, an annular cross-sectional space 160 is provided by the battery mounting pipe 130, the vertical support plate 112 of the first side sill inner patch 110, a part of the upper support plate 111, and a part of the lower support plate 113. The annular cross-sectional space serves to subsidiarily absorb the load and collision energy resulting from a side collision and a small overlap collision.

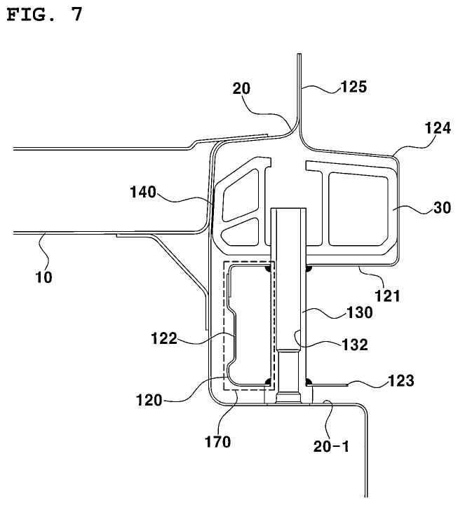

As shown in FIGS. 5 and 7, the second side sill inner patch 120 may include an upper support plate 121 that is fastened to the bottom part of the side sill inner reinforcement 30 with bolts and simultaneously welded to the upper-end part of the battery mounting pipe 130. The upper support plate 121 is horizontally arranged at the lower position of the side sill inner reinforcement 30. The second side sill inner patch 120 may also include a lower support plate 123 that is welded to the lower circumference part of the battery mounting pipe 130 and horizontally arranged above the lower plate 20-1 of the side sill inner panel 20. Additionally, the second side sill inner patch 120 may include a vertical support plate 122 that is integrally connected between the inner end of the upper support plate 121 and the inner end of the lower support plate 123. The vertical support plate 122 is arranged parallel to the outer surface of the side sill inner panel 20 in the vertical direction.

In addition, as shown in FIGS. 5 and 7, the second side sill inner patch 120 may further include a protector 124 that is bent in two steps from an outer end part of the upper support plate 121 and extends upward to cover a part of the outer and upper surfaces of the side sill inner reinforcement 30. Additionally, the second side sill inner patch 120 may include an upper coupling plate 125 extending from an upper-end part of the protector 124 and joined to the upper-end part of the side sill inner panel 20 through welding or the like.

As indicated by the dotted box in FIG. 7, an annular cross-sectional space 170 is provided by the battery mounting pipe 130, the vertical support plate 122 of the second side sill inner patch 120, a part of the upper support plate 121, and a part of the lower support plate 123. The annular cross-sectional space serves to subsidiarily absorb the load and collision energy resulting from a side collision and a small overlap collision.

The side sill inner patch 100 including the first and second side sill inner patches 110 and 120 is located between the bottom part of the side sill inner reinforcement 30 and the lower circumference part of the respective battery mounting pipes 130. The battery mounting pipes 130 support the weight (loads) of the side sill inner reinforcement 30, and in the event of a side collision or a small overlap collision, subsidiarily absorb the collision energy while being deformed.

The inner surface of the side sill inner panel 20 and the outer surface of the side sill inner reinforcement 30 are bonded using an adhesive or adhesive tape 140.

Accordingly, the side sill inner reinforcement 30 and the side sill inner panel 20 are surface-bonded to each other by/using the adhesive or adhesive tape 140. As a result, sagging, movement, and deformation of the side sill inner reinforcement 30 due to its own weight may be prevented.

To elaborate, the side sill inner reinforcement 30 is supported by the plurality of side sill inner patches 100, the battery mounting pipes 130, and the like and simultaneously allowed to adhere to the side sill inner panel 20 using the adhesive or adhesive tape 140. As a result, effects such as preventing the side sill inner reinforcement 30 from sagging due to its own weight, preventing vibration due to vehicle body vibration and external forces, and preventing noise caused by shaking may be achieved.

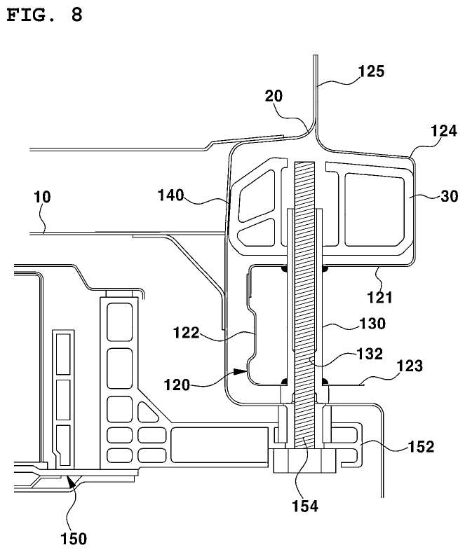

FIG. 8 is a sectional view of an example in which a battery pack is assembled in a device for reinforcing a side part of an electric vehicle body according to the present disclosure.

The battery mounting pipe 130 is a hardware part for securing the battery pack 150 disposed in the bottom part space of the seat-cross member 10. As mentioned earlier, when the lower-end part of the battery mounting pipe 130 is coupled to the lower plate part 20-1 of the side sill inner panel 20, the female thread part 132 provided on the inner diameter part of the battery mounting pipe 130 may be opened and exposed towards an underneath side of the lower plate part 20-1 of the side sill inner panel 20 in order to mount the battery pack 150.

Accordingly, after a flange part 152 of the battery pack 150 is brought into close contact with the bottom surface of the lower plate part 20-1 of the side sill inner panel 20, as shown in FIG. 8, the battery fastening bolt 154 is inserted into and fastened, from the flange part 152, to the female thread part 132 of the battery mounting pipe 130. As a result, the battery pack 150 may be placed in a firmly secured state in the bottom part space of the seat-cross member 10.

On the outer surface of the side sill inner reinforcement 30, a side sill outer panel, which covers and protects the side sill inner reinforcement 30, is joined through welding or similar methods to the inner surface of the side sill inner panel 20.

The process of supporting the load and absorbing collision energy by the side reinforcement device of the electric vehicle body configured as described above is as follows.

The battery mounting pipe 130 functions to support the load of the side sill inner reinforcement 30, similar to the role of a pillar in a building, and to prevent the side sill inner reinforcement 30 from sagging.

The side sill inner patch 100, including the first and second side sill inner patches 110 and 120, also functions to support the load of the side sill inner reinforcement 30 together with the battery mounting pipe 130. As a result, the side sill inner patch 100 prevents sagging, movement, and deformation of the side sill inner reinforcement 30.

In particular, as indicated by a dotted box in FIG. 6, an annular cross-sectional space is provided by the battery mounting pipe 130, the vertical support plate 112 of the first side sill inner patch 110, and a part of the upper support plate 111. As a result, the annular cross-sectional space serves to subsidiarily absorb the load and collision energy resulting from a side collision and a small overlap collision.

In addition, as indicated by a dotted box in FIG. 7, an annular cross-sectional space is provided by the battery mounting pipe 130, the vertical support plate 122 of the second side sill inner patch 120, a part of the upper support plate 121, and a part of the lower support plate 123. As a result, the annular cross-sectional space serves to subsidiarily absorb the load and collision energy resulting from a side collision and a small overlap collision.

Therefore, the side sill inner reinforcement 30 serves to mainly absorb the load and collision energy resulting from a collision, and the annular cross-sectional space provided by the battery mounting pipe 130, the vertical support plate 122 of the second side sill inner patch 120, a part of the upper support plate 121, and a part of the lower support plate 123 serves to subsidiarily absorb the load and collision energy resulting from a collision. Accordingly, the pushing and deformation movement of the side sill inner reinforcement 30, resulting from the load and collision energy in a side collision and a small overlap collision, may be minimized.

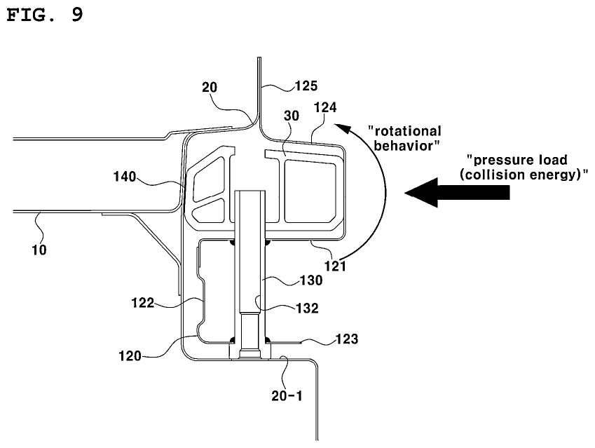

As shown in FIG. 9, the side sill inner reinforcement 30 undergoes a rotational behavior (counterclockwise based on the direction shown in FIG. 9) due to the load and collision energy from a side collision and a small overlap collision.

Along with the battery mounting pipe 130, the annular cross-sectional space (depicted part in the dotted box in FIG. 7) provided by the battery mounting pipe 130, the vertical support plate 122 of the second side sill inner patch 120, a part of the upper support plate 121, and a part of the lower support plate 123, serves to suppress the initial rotational behavior of the side sill inner reinforcement 30 in the event of a side collision or a small overlap collision. Accordingly, stable deformation of the side sill inner reinforcement 30 may be induced to absorb collision energy.

Although the present disclosure has been described in detail with the embodiments above, the scope of rights of the present disclosure is not limited to the above-described embodiments. Various modifications and improvements made by those having ordinary skill in the art, using the basic concept of the present disclosure as defined in the claims below, are also within the scope of the rights of the present disclosure.

What is claimed is:

1. A device for reinforcing a side part of an electric vehicle body, the device comprising:
a side sill inner panel configured to be coupled to each opposite side of a seat-cross member;
a side sill inner reinforcement configured to be attached to an outer surface of the side sill inner panel; and
a battery mounting pipe including:
an upper part configured to be coupled to a bottom part of the side sill inner reinforcement, and
a lower part configured to be coupled to a lower plate part of the side sill inner panel.

2. The device of claim 1, further comprising a side sill inner patch,
wherein the side sill inner patch includes:
an upper part configured to be coupled to a bottom part of the side sill inner reinforcement, and
a lower part configured to be coupled to a lower circumference part of the battery mounting pipe.

3. The device of claim 2, wherein the side sill inner patch comprises a first side sill inner patch provided in a structure configured to support the bottom part of the side sill inner reinforcement, along with the battery mounting pipe.

4. The device of claim 2, wherein the side sill inner patch further comprises a second side sill inner patch configured to cover a part of an outer surface and an upper surface of the side sill inner reinforcement, wherein the second side sill inner patch and the battery mounting pipe are configured to form a structure configured to support the bottom part of the side sill inner reinforcement, and.

5. The device of claim 3, wherein the first side sill inner patch comprises:
an upper support plate configured to be fastened to the bottom part of the side sill inner reinforcement with bolts and welded to an upper-end part of the battery mounting pipe;
a lower support plate configured to be welded to the lower circumference part of the battery mounting pipe; and
a vertical support plate configured to be integrally connected between an inner end of the upper support plate and an inner end of the lower support plate and arranged parallel to the outer surface of the side sill inner panel in a vertical direction.

6. The device of claim 5, wherein an annular cross-sectional space for subsidiary absorption of collision energy is formed by the battery mounting pipe, the vertical support plate of the first side sill inner patch, a part of the upper support plate of the first side sill inner patch, and a part of the lower support plate of the first side sill inner patch.

7. The device of claim 4, wherein, the second side sill inner patch comprises:
an upper support plate configured to be fastened to the bottom part of the side sill inner reinforcement with bolts and welded to an upper-end part of the battery mounting pipe;
a lower support plate configured to be welded to the lower circumference part of the battery mounting pipe;
a vertical support plate configured to be integrally connected between an inner end of the upper support plate and an inner end of the lower support plate and arranged parallel to the outer surface of the side sill inner panel in a vertical direction;
a protector configured to be bent in two steps from an outer end part of the upper support plate and configured to extend upward to cover the part of an outer surface and an upper surface of the side sill inner reinforcement; and
an upper coupling plate extending from an upper-end part of the protector and joined to an upper-end part of the side sill inner panel through welding.

8. The device of claim 7, wherein an annular cross-sectional space for subsidiary absorption of collision energy is formed by the battery mounting pipe, the vertical support plate of the second side sill inner patch, a part of the upper support plate of the second side sill inner patch, and a part of the lower support plate of the second side sill inner patch.

9. The device of claim 1, wherein an outer surface of the side sill inner reinforcement and an inner surface of the side sill inner panel are bonded using an adhesive or adhesive tape.

10. The device of claim 1, wherein the battery mounting pipe includes an inner diameter part formed with a female thread part.

11. The device of claim 10, wherein, when a lower-end part of the battery mounting pipe is coupled to the lower plate part of the side sill inner panel, the female thread part is exposed beneath the lower plate part of the side sill inner panel.

12. The device of claim 11, wherein a flange part of a battery pack is in close contact with a bottom surface of the lower plate part of the side sill inner panel, and a battery fastening bolt is inserted into and fastened, from the flange part, to the female thread part of the battery mounting pipe.
